(19) United States
(12) Patent Application Publication
(10) Pub. No.: US 2006/0008002 A1
(43) Pub. Date: Jan. 12, 2006

(54) Scalable video encoding

(75) Inventor: Ihor Kirenko, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/528,944

(22) PCT Filed: Aug. 18, 2003
(86) PCT No.: PCT/IB03/03673

§ 371 Date: Mar. 23, 2005

(30) Foreign Application Priority Data
Sep. 27, 2002 (EP) 02079064.8

(51) Int. Cl. H04B 1/66; H04N 11/02; H04N 11/04; H04N 7/12

(52) U.S. Cl. 375/240.11; 375/240.12; 375/240.08

(57) ABSTRACT

A video encoder comprises a video frame receiver (101) connected to a processor (103) deriving relative frames from the received video frames and predicted frames. The processor is connected to a Discrete Fourier Transform (DCT) processor (105) which again is connected to a quantiser (107) for generating quantised spatial frequency coefficients for the relative frame. The output of the quantiser (107) is fed to a splitter that splits the data subset having low frequency components and a second data subset having frequency components. The first subset is used in the encoding loop comprising an inverse quantiser (111), inverse DCT processor (113), motion compensation processor (115, 117) and predicted frame processor (104). Hence, the encoding loop is simplified by only considering a reduced data set for each frame. A transmitter (119) transmits the video data as a progressively scalable stream for both the first and second data subsets.

### FIELD OF THE INVENTION

The invention relates to a video encoder and a method of video encoding therefor and in particular but not exclusively to a video encoding system for generating compressed video signals.

### BACKGROUND OF THE INVENTION

Video signals are increasingly being broadcast and distributed as digital video signals. In order to maintain low data rates, various forms of video compression are normally used. Consequently, a number of different video compressions standards have been defined. A widely used compression standard is the MPEG-2 (Moving Picture Expert Group) standard, which is used in for example terrestrial and satellite digital TV broadcasting, DVDs and digital video recorders.

The MPEG-2 video standard comprises a number of different levels and profiles allowing for different data rates and the complexity of encoders and decoders to be traded off against the video quality.

In a given video system, a number of different video coding schemes or variants may be used. Therefore, in order to transmit one compressed video stream to decoders having different functionality, capabilities and requirements, scalable coded video streams are sometimes used. The scalability allows the decoder to take a portion of the video stream and decode a full picture therefrom. The quality level of the decompressed image depends on how much of the video stream is used by the decoder, and on how the scalable compressed stream is organised.

In current video compression standards spatial, Signal to Noise Ratio (SNR) and temporal scalability is achieved through a layered structure. The encoded video information is divided into two or more separate streams corresponding to the different layers. In such standard scalable structures, the base layer (BL) is coded using a hybrid predictive encoding loop as in a non-layered encoding scheme. This results in a data stream which when decoded can produce the full picture but at low quality. The enhancement layers (EL) are linked to the base layer and comprise data for the residual signal relative to the picture of the base layer. The EL thereby delivers an enhancement data stream, which when combined with the base layer information gives an upper video quality level. Hence, the additional enhancement layer provides a scalability of the video signal since it is optionally used by the decoder to provide an improvement in the quality of the video signal.

The conventional scalability has a number of disadvantages. For example, the scalability is very inflexible as the only scalability is available in the enhancement layers. In order to achieve higher scalability, more enhancement layers are needed leading to increased coding overhead and reduced compression efficiency.

Recently, other schemes for scalable video encoding have started to emerge. Some schemes provide for a fully progressive structure wherein a single progressive data stream is delivered. This data stream can be partially decoded thereby providing the ability to adapt to varying transport conditions, receiver capabilities and applications requirements. However, a significant problem with the implementation of fully progressive scalability within a motion predictive video-coding scheme is the vulnerability to the so-called drift-effect. This occurs when the reference frame used for motion compensation in the encoding loop is not available at the decoder side and results in a significantly decreased video quality. Proposed solutions to this problem require a high increased complexity of the decoders.

A video encoder known as a Fine Granular Scalability (FGS) encoder has been proposed in “Embedded DCT and Wavelet Methods for Fine Granular Scalable Video: Analysis and Comparison”, M. van der Schaar, Y. Chen, H. Radha Image and Video Communications and Processing 2000, Proc. SPIE, vol. 2974, p. 643-653, January 2000. The FGS encoder combines the progressive and layered approaches and provide for the encoded video signal to comprise two or more layers. The base layer comprises basic video data, which is efficiently compressed by a non-scalable coder using motion prediction. The enhancement layer comprises data corresponding to the difference between the original picture and the transmitted base layer picture. The data of the enhancement layer is transmitted as a progressive data stream. This is achieved by bit plane coding wherein the most significant bit of all data values are transmitted first, followed by the next most significant bit of all data values and so on, until the least significant data bit of all data values is transmitted.

However, a number of disadvantages are associated with the FGS encoder including that it is a relatively high complexity decoder and coder requiring significant computational resource and memory size, and that it provides for SNR scalability only so that additional layers are required for e.g. spatial scalability.

A common problem for digital video encoders is furthermore that in order to achieve low data rates, complex digital signal processing is required. Specifically, estimation, prediction and processing associated with motion compensation is complex and highly resource demanding. This requires the use of high performance digital signal processing and results in increased cost and power consumption of the video encoders.

Consequently, existing coding systems tend to be resource demanding, complex and inflexible and an improved video encoding system would be advantageous.

### SUMMARY OF TH INVENTION

Accordingly, the Invention seeks to provide an improved video encoding system alleviating or mitigating one or more of the above disadvantages singly or in combination.

Accordingly there is in accordance with a first aspect of the invention provided a video encoder for encoding video frames; the video encoder comprising: a receiver for receiving the video frames; a processor for deriving relative frames from the received video frames and predicted frames; a splitter for splitting the data of the relative frames into first data subsets and second data subsets; a motion compensation processor for generating motion compensation parameters in response to the received video frames and only the first data subsets of the first and second data subsets; a predicted frame processor for generating the predicted frames in response to the motion compensation parameters, the first data subsets and the received video frames; and a transmitter for transmitting a video signal comprising the motion compensation parameters, the first data subsets and the second data subsets.

Advantages of the invention thus include a significantly reduced complexity of the encoder as only a reduced data set is used in the encoding loop. Scalability may be provided by the separation into first and second data subsets. Further as motion compensation is based on only the first data subsets, which may be transmitted as a base layer, an improved resistance to drift errors can be achieved

According to a first feature of the invention, the video encoder comprises a frequency transformation processor for performing a frequency transformation on the relative frames prior to splitting, and an inverse frequency transformation processor for performing an inverse frequency transformation on the first data subsets prior to generation of motion compensation parameters. This allows for processing in the frequency domain thereby allowing the splitting into the first and second data subset to be performed in the frequency domain. Preferably, the frequency transformation is a discrete cosine transformation.

According to another feature of the invention, the video encoder further comprises a quantiser for quantising the relative frames prior to splitting and an inverse quantiser for performing an inverse quantisation on the first data subsets prior to generation of motion compensation parameters. The quantisation enables significant compression of the data as higher frequencies tend to have low coefficients that may be truncated to zero.

According to a different feature of the invention, the transmitter is operable to transmit the motion compensation parameters and the first data subsets as a base layer and the second data subsets as at least one enhancement layer. This provides for an efficient scalability of the encoded video stream. Further, as motion compensation is limited to the base layer the impact of drift effects are significantly reduced.

According to another feature of the invention, the first data subset comprises data of relatively higher quality importance than data of the second data subsets. Preferably, the first data subsets comprise data corresponding to lower spatial frequencies than data of the second data subsets. Hence, the first data subsets comprise a disproportionately high information content for the video frame being encoded. Thus, as the processing is of the most important data, the impact of basing the motion compensation on a reduced data set is reduced.

According to another feature of the invention, the splitter is operable to divide data of the relative frames having spatial frequencies below a threshold into the first data subsets and data of the relative frames having spatial frequencies not below the threshold into the second data subsets. This provides for a very simple and easy to implement splitting yet with high performance.

According to a different feature of the invention, the transmitter is operable to generate and transmit progressive scalable data streams for at least one of the first and second data subsets. Preferably, the transmitter is operable to transmit the data of at least one of the first and second data subsets in order of decreasing video quality importance and specifically the transmitter is operable to transmit the data of the at least one of the fist and second data subsets in order of increasing associated spatial frequency. Hence, one or more of the data subsets are transmitted in a scalable progressive manner, thereby allowing a variety of decoders to be used as well as improved error performance.

According to another feature of the invention, the transmitter is operable to arrange the data of the at least one of the first and second data subsets into subband groups comprising all data values of at least one of the relative frames having substantially identical associated spatial frequencies, and to sequentially transmit each subband group in order of increasing associated spatial frequency. Hence, a very efficient progressive scalable data stream is generated allowing for a decoder to generate an entire frame on the basis of only a subset of the received data. As more data is received, the quality of the frame can be improved. Furthermore, the system allows for both spatial and Signal to Noise Ratio (SNR) scalability.

According to a different feature of the invention, the video encoder is a video transcoder and the received video frames are compressed video frames. The video encoder may thus provide a reduction of bit-rate and/or increase of compression ratio and/or progressively scalable data stream from an already compressed video signal.

According to a second aspect of the invention, the method comprising the steps of: receiving the video frames; deriving relative frames from the received video frames and predicted frames; splitting the data of the relative frames into first data subsets and second data subsets; generating motion compensation parameters in response to the received video frames and only the first data subsets of the first and second data subsets; generating the predicted frames in response to the motion compensation parameters, the first data subsets and the received video frames; and transmitting a video signal comprising the motion compensation parameters, the first data subsets and the second data subsets.

These and other aspects and advantages of the invention will be apparent from and elucidated with reference to the embodiments described hereinafter.

### BRIEF DESCRIPTION OF THE DRAWINGS

An embodiment of the invention will be described, by way of example only, with reference to the drawings, in which

FIG. 1 is an illustration of a video encoder in accordance with an embodiment of the invention;

FIG. 2 is an illustration of an example of splitting of a DCT coefficient block in accordance with an embodiment of the invention; and

FIG. 3 is an illustration of an example of regrouping of DCT coefficients in accordance with an embodiment of the invention

### DESCRIPTION OF PREFERRED EMBODIMENTS

A preferred embodiment of the invention will in the following be described with specific reference to the MPEG-2 video compression scheme, but it will be apparent that the invention is not limited to this application and applies equally to many other video encoding schemes including non-compressed video encoding schemes and transcoding schemes.

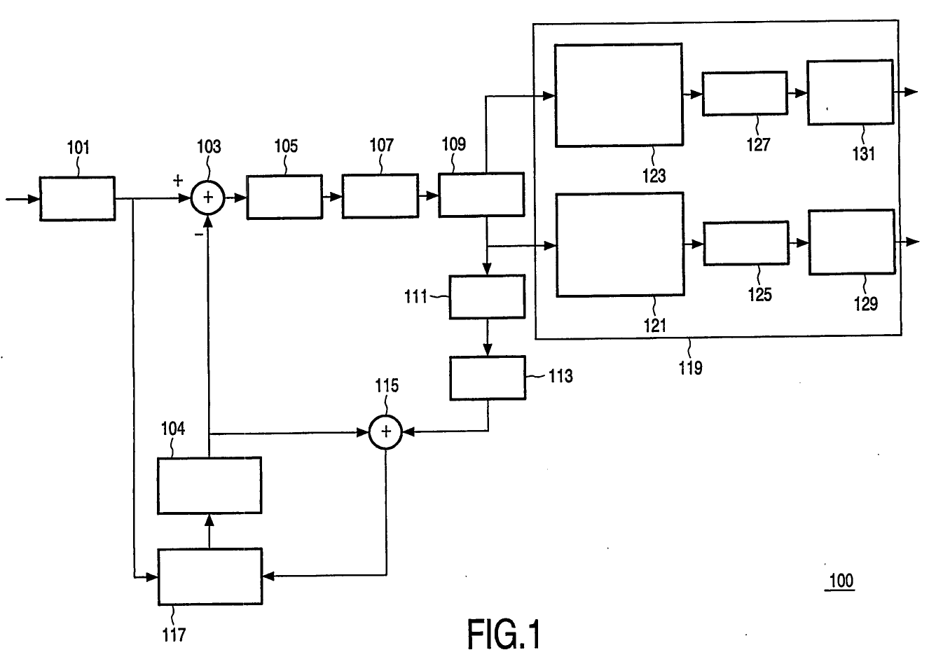

FIG. 1 is an illustration of a video encoder 100 in accordance with a preferred embodiment of the invention.

The video encoder 100 comprises a receiver 101 for receiving video frames. In the preferred embodiment, the video receiver is simply a functional block providing a suitable interface to a video source (not shown), which produces the video frames to be encoded. Depending on the application, the video source may for example be a video camera, a video storage unit, a video editing system or any other suitable means for providing video frames.

The video encoder 100 further comprises a first processor 103 for deriving relative frames from the received video frames and predicted frames. The first processor 103 is connected to the receiver 101 and to a predicted frame processor 104 that generates the predicted frame. In the preferred embodiment, the first processor 103 simply comprises a subtraction unit, which subtracts a predicted frame from the received video frame. As will be described in the following, the predicted frame is generated based on processing of previous frames. The relative frame thus comprises data associated with the residual data from a comparison between the actual received video frame and the predicted frame generated by the decoder.

The output of the first processor 103 is connected to a frequency transformation processor 105, which converts the data values of the relative frame into a two dimensional spatial frequency domain. In the preferred embodiment, the frequency transformation is a Discrete Cosine Transform (DCT), the implementation of which is well known in art. The output of the frequency transformation processor 105 is in the preferred embodiment connected to a quantiser 107. The quantiser 107 quantises the coefficients of the frequency transformation according to a quantising profile, which in the preferred embodiment simply maps the coefficient values into quantisation steps of equal size. Since video signals typically comprise more low spatial frequency components than high spatial frequency components, many coefficients for the higher spatial frequencies are relatively small. The quantisation is typically set such that many of these values will be quantised to zero. This will have relatively little impact on video quality but provides for efficient compression as zero coefficients can be communicated very efficiently.

Although the invention is equally applicable to encoding systems not comprising functionality for performing frequency transformations and quantisation, the preferred embodiment includes these aspects since they provide for efficient compression and thereby significantly reduced data rate transmission requirements.

The quantiser 107 is connected to a splitter 109 that splits the data of the relative frame into a first data subset and a second data subset. In some embodiments, the second data subset is further divided into a plurality of subsets. In the preferred embodiment, the split is such that the output data of the quantiser which has a relatively high impact on the video quality is included in the first data subset, and the output data which has a relatively lower impact on the video quality is included in the second data subset. Hence, the first data subset corresponds to a reduced amount of data but with a disproportionately high information content related to the video frame.

The splitter 109 is connected to an inverse quantiser 111. However, this connection does not carry the whole relative frame but only the data of the first subset.

Hence, the following operations need only to be performed on a reduced subset rather than on the whole data set of the relative frame. The inverse quantiser performs an operation which is (to some extent) complementary to the quantisation performed in the quantiser 107. It performs a scaling or weighting operation that is complementary to the operation performed by the quantiser 107. Hence, if the quantisation for example included dividing the data by a factor of two, the inverse quantisation will multiply the data by a factor of two. However, it will not add any fractional values that were lost in the original quantisation. In this way, the inverse quantisation mimics the operation performed in a receiving video decoder and the output of the inverse quantiser thus corresponds (in the frequency domain) to the frame that will be generated in the decoder.

The inverse quantiser 111 is connected to an inverse frequency transformation processor 113 for performing an inverse frequency transformation on the first data subset.

The inverse transformation performed is the complementary operation to that performed by the frequency transformation processor 105 and is thus in the preferred embodiment an inverse DCT operation. Similarly to the inverse quantisation, the inverse frequency transformation corresponds to that which is performed in the video decoder and the output data from the inverse frequency transformation processor 113 is thus a relative frame corresponding to the relative frame as it will be generated by the decoder.

In the preferred embodiment, the inverse frequency transformation processor 113 is connected to a combiner 115 which adds the relative frame generated by the frequency transformation processor 113 to the predicted picture used by the first processor 103. Consequently, the output of the combiner 115 corresponds to the video frame that will be generated by a video decoder from the predicted frame and the first data subset.

The output of the combiner 115 is connected to a motion compensation processor 117. The motion compensation processor 117 is furthermore connected to the receiver 101 and therefrom receives the original video frames. Based on the video frames and the frames generated from the first data subset, the motion compensation processor 117 generates motion compensation parameters. It is within the contemplation of the invention that any known method of motion compensation for video signals may be used without subtracting from the invention. Specifically, the motion compensation may include motion detection by comparison of picture segments of subsequent frames. It may generate motion compensation parameters comprising motion vectors indicating how a specific picture segment is moved from one frame to the next. Hence, specifically the motion compensation processing and motion compensation parameters may comprise the processing and parameters prescribed from and known in connection with the MPEG-2 video compression scheme.

The motion compensation processor 117 is connected to the predicted frame processor 104. The predicted frame processor 104 generates the predicted frames in response to the motion compensation parameters and the received video frames. In the preferred embodiment, the predicted frame processor 104 and the motion compensation processor 117 are implemented as a single functional unit and the generation of the predicted frame includes consideration of the data generated at the output of the combiner 115.

Hence, in the preferred embodiment, the motion compensation and the generation of the predicted frame is based on the received frames and the first data subsets of one or more frames. However, the data of the second subset are not included in these processes, and consequently the processing need only operate on a reduced data set thereby reducing the complexity and resource requirements significantly.

The video encoder further comprises a transmitter 119 for tranitting a video signal comprising the motion compensation parameters, the first data subsets and the second data subsets. In a simple embodiment this data is simply transmitted as a single data stream by a suitable transmitter for the communication channel over which the video signal is to be communicated. However, preferably the video encoder transmits the motion compensation parameters and the first data subsets as a first data stream, and the second data subsets as at least a second separate data stream. In the preferred embodiment, the transmitter 119 is operable to transmit the motion compensation parameters and the first data subsets as a base layer and the second data subsets as at least one enhancement layer.

As the first data subset in the preferred embodiment comprises data of higher importance for the video quality than the second data subsets, a decoder may in this simple embodiment derive a full frame based on only the motion compensation parameters and the data of the first data subsets. The derived picture will be of reduced quality but can be further enhanced by decoders optionally processing the data of the second data subsets. Contrary to conventional techniques, the different layers are in this embodiment not achieved by splitting or dividing the final encoded video signal but is performed as an integral part of the video encoding. Specifically, the video encoding loop is implemented using only the data related to the base layer thereby providing a significant complexity reduction.

As the motion compensation of the loop is furthermore based only on data of the first data subset, the motion compensation processing in both video encoder and video decoder are only affected by the base layer. Therefore, any loss of enhancement layer information (second data subset) does not lead to the appearance of drift error. Since the base layer (first data subset) comprises essentially lower frequency information, the reconstructed image may be blurred but it will also be free from high-frequency noise, which may complicate motion estimation-compensation. Consequently, the motion estimation-compensation processing for the low-frequency images (first data subset) is simpler than for the original frames at both the encoding and decoding sides.

Any suitable criterion or algorithm for splitting the data of the relative frame (in the preferred embodiment following the DCT and quantisation) into a first and second data subset may be used without detracting from the invention. Preferably, the first data subset comprises data of relatively higher quality importance than data of the second data subsets, and in particular for the preferred embodiment, the first data subset comprises data corresponding to lower spatial frequencies than data of the second data subset. In the preferred embodiment, this is implemented by the splitter comprising means for dividing the data of the relative frame having spatial frequencies below a given threshold into the first data subset, and data of the relative frames having spatial frequencies not below the threshold into the second data subset.

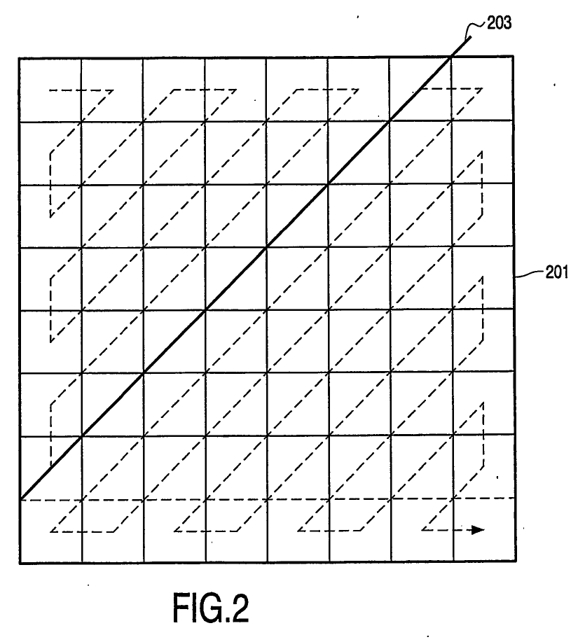

FIG. 2 illustrates the process of the preferred embodiment for splitting a quantised DCT block 201 comprising 64 coefficients (which is the standard used in for example MPEG-2) into two data subsets. In the example given a threshold 203 for splitting is given in terms of a two dimensional spatial frequency level as indicated by the bold line. All coefficients located above the level of splitting (i.e. towards the upper left corner corresponding to lower spatial frequencies) are included in the first data subset. The residual high-frequency DCT coefficients located beneath the level of splitting (i.e. towards the lower right corner) are included in the second data subset. The level of splitting is transmitted to the video decoder along with the coded coefficients within the first and/or second data subset data stream. This provides for a very simple and flexible method of splitting the data and allows for the splitting level to be dynamically varied. In accordance with this embodiment, the level of splitting may even be individually set for each DCT coefficient block, and may be dependent on the process of adaptive quantization of DCT coefficients. The control of the level of splitting would preferably be implemented as part of the data rate control mechanism.

In the preferred embodiment the splitting is thus based on a diagonal splitting level and on a zig zag scanning structure but it will be clear that many other splitting algorithms are possible including for example other methods of selecting a low-frequency region such as rectangular-shape zonal selection.

In contrast to for example the FGS video encoder, wherein the bitplane scalability provides only an SNR scalability, the splitting of the frequency coefficients as performed in the preferred embodiment allows for generation of a spatial resolution scalable stream. Specifically, the base layer comprising predominantly low frequency information may be used for decoding frames at lower spatial resolution.

Further, in the preferred embodiment, the transmitter 119 comprises functionality for generating individually scalable data streams for at least one and preferably both of the first and second data subsets respectively. Preferably this is done by the transmitter 119 comprising functionality for transmitting the data of at least one of the first and second data subsets in order of decreasing video quality importance, and in particular in order of increasing associated spatial frequency.

Specifically in the preferred embodiment, the transmitter 119 is operable to arrange the data of the first and/or second data subsets into subband groups comprising all data values of at least one of the relative frames having substantially identical associated spatial frequencies. The transmitter 119 further comprises functionality for sequentially transmitting each subband group in order of increasing associated spatial frequency.

The implementation of the transmitter 119 in the preferred embodiment is illustrated in FIG. 1. The splitter 109 is connected to a first subband processor 121 and a second subband processor 123. The first subband processor 121 is fed the data from the first data subset, and the second subband processor 123 is fed the data from the second data subset. The subband processors 121, 123 regroup the coefficients from a plurality of DCT blocks into groups of coefficients from DCT blocks of the whole frame having identical or similar spatial frequencies. Preferably all DCT blocks of a frame are regrouped such that each group comprises all DCT coefficients of the corresponding spatial frequency.

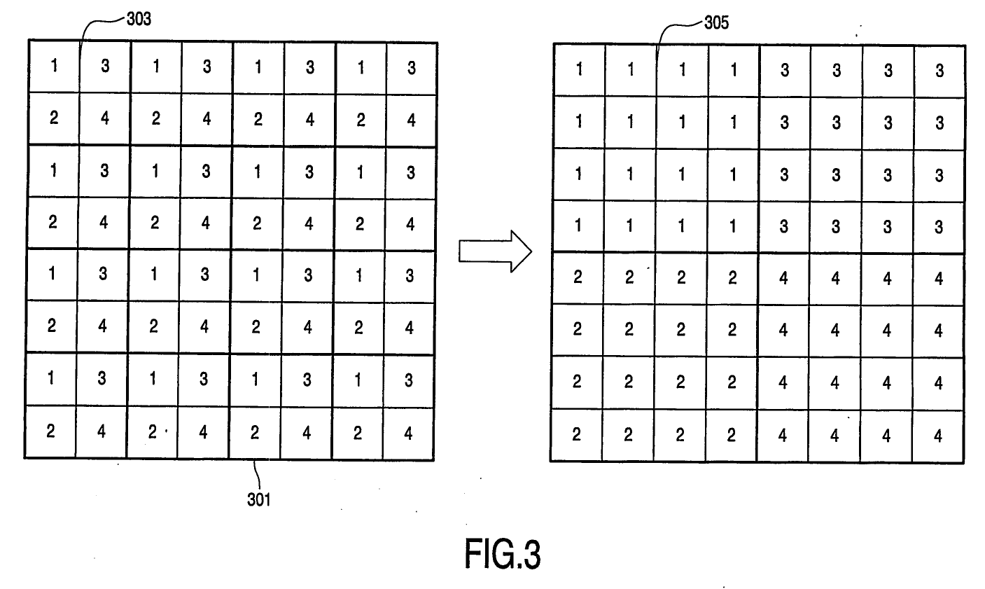

FIG. 3 is an illustration of an example of regrouping of DCT coefficients in accordance with a preferred embodiment of the invention. In this example, a first frame 301 comprises 16 DCT blocks 303 each having four coefficients corresponding to four subbands denoted 1,2,3,4 in the figure. The coefficients are reordered in the respective subband processor such that all coefficients for subband 1 are grouped together. Consequently, in the specific example, the subband processor 121, 123 generates four groups 305 each having sixteen coefficients. Hence, the subband processor 121, 123 generates a number of groups corresponding to the number of coefficients in the DCT with each group corresponding to one DCT frequency or subband. The number of coefficients in each group is identical to the number of DCT blocks in a given frame.

Each of the subband processors 121, 123 are connected to a scanning processor 125, 127 which reads the reorganised coefficients in a suitable order to generate a sequential data stream. Preferably the reorganised coefficients are read out in order of increasing spatial frequencies, as lower spatial frequencies tend to contain more information and be of higher importance for the resulting video quality. Thus, in the example of FIG. 2, subband group 1 is read out first, followed by subband group 3, then subband group 2 and finally subband group 4. Hence, in the preferred embodiment a zig zag scan is used but in other embodiments other scan orders may be applied.

Each of the scanning processors 125, 127 are connected to coders 129, 131 which perform a suitable coding of the data for transmission over a suitable communication channel. Preferably, the coders 129, 131 comprise run length coding and/or variable length coding. As is known in the art, these coding schemes provide a loss free data compression which is especially efficient for data streams having long sequences of identical values. Specifically, the run length coding and variable length coding schemes are highly efficient for data streams having long sequences of zero values, and these encoding schemes are therefore extremely efficient for compressing quantised coefficients.

Hence, in the preferred embodiment, the lower frequency coefficients of the DCT blocks are reorganized into subband groups and appropriately scanned to form a data stream, which may function as a base layer. The residual higher-frequency coefficients of each block are reorganized into higher-frequency subband groups and appropriately scanned to form a second data stream which may function as an enhancement layer. In this way, a progressively scalable or embedded stream is created for both the base layer and the enhanced layer. Specifically, as the most important data for the whole picture are transmitted first, a picture representative of the whole video frame can be regenerated (reconstructed) from only an initial subset of the data of the base layer. As more data is received the video quality can be improved.

Furthermore, the described system allows for both spatial and SNR scalability as it can provide both progressive fidelity and/or progressive resolution. In the first case, a partially received stream may be used for decoding the full size image. The base layer provides a blurred image of the full size with only low-frequency content, and this is refined by coefficients from the enhanced layer stream. In case of progressive resolution, low-frequency coefficients of the base layer are used for construction of an image with lower spatial resolution. The enhancement layer information is used to obtain images with increasing resolution.

Additionally, motion prediction and compensation is exploited within the base layer, and therefore usage of base layer information as a reference during decoding will remove or reduce the possible drift effect. Also, if only part of the base layer information is received by a decoder, the consequences of the appeared drift effect would be reduced due to the fact, that the most important coefficients (from the low-frequency subbands) of the whole image are transmitted first. The extent of the drift error will progressively depend on the number of received subband groups of the base layer.

Also, the re-grouping of DCT coefficients from all blocks of the whole frame into subbands of the same spatial frequency will increase the correlation between consecutively transmitted coefficient values. This increased correlation can be used by the variable-length coders to provide higher loss free compression thereby achieving a lower data rate for the same video quality.

In some embodiments, the transmitter additionally or alternatively uses bit-plane scanning. For example, all the most significant bits of all coefficients of the first subband group may be transmitted first, followed by all the next most significant bits of all coefficients of the first subband group etc. When all or most of bits of the coefficients of the first subband group have been communicated, the most significant bits of all coefficients of the second subband group may be communicated and so on.

In some embodiments the received video frames are themselves compressed video frames. Hence, the encoder is in some embodiments specifically a transcoder. Preferably, the encoder in some of these embodiments provides a change in the data rate between the received and generated video signal or a transcoding from non-scalable into scalable compressed stream. Specifically, the video encoder may not decode the received compressed video frames to the pixel domain but operate in the frequency domain. Hence, the video encoder may in this case not include frequency transforms or the functional relation between the frequency transforms and other processing units may be altered.

In the preferred embodiment of an MPEG-2 scheme, a number of different types of frames may be transmitted including Intra (I) frames, Predicted (P) frames and Bidirectional (B) frames. In this embodiment, the relative frames are for P-frames determined by subtraction of the predicted frame from the received video frame thereby creating a residual frame. For B-frames, two predicted frames may be used or equivalently the predicted frame may comprise two frames or be a composite of two frames. Hence, the relative frame is a residual frame comprising information relative to at least one and possible more frames. For the I-frames, the relative frame is equivalent to the received frame, and no subtraction of a predicted frame is performed. In other words, for 1 frames, the relative frame is relative to an empty predicted frame corresponding to the predicted frame being blank (i.e. comprising null data). Hence, in the preferred embodiment, the relative frame may for example be an MPEG-2 I-frame, P-frame or B-frame.

The current invention may be applied to all frames or to a subset of the frames. As such the invention may be applied to frames randomly, in a structured manner or in any other suitable fashion. Specifically, in the MPEG-2 video encoding scheme, a number of different types of frames may be transmitted including Intra (I) frames, Predicted (P) frames and Bidirectional (B) frames. The splitting of the relative frames into two or more subsets may be performed on all of these frames, on only one or two of the frame types or may be applied to only a subset of the frames of the different frame types.

For example, a conventional video encoding may be provided for all P-frames and/or B-frames with the splitting into data subsets only being applied to all or some of the I-frames.

The invention can be implemented in any suitable form including hardware, software, firmware or any combination of these. However, preferably, the invention is implemented as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with the preferred embodiment, it is not intended to be limited to the specific form set forth herein. Rather, the scope of the present invention is limited only by the accompanying claims.

1. A video encoder for encoding video frames; the video encoder comprising:
a receiver for receiving the video frames;
a processor for deriving relative frames from the received video frames and predicted frames;
a splitter for splitting the data of the relative frames into first data subsets and second data subsets;
a motion compensation processor for generating motion compensation parameters in response to the received video frames and only the first data subsets of the first and second data subsets;
a predicted frame processor for generating the predicted frames in response to the motion compensation parameters, the first data subsets and the received video frames; and
a transmitter for transmitting a video signal comprising the motion compensation parameters, the first data subsets and the second data subsets.

2. A video encoder as claimed in claim 1 further comprising a frequency transformation processor for performing a frequency transformation on the relative frames prior to splitting, and an inverse frequency transformation processor for performing an inverse frequency transformation on the first data subsets prior to generation of motion compensation parameters.

3. A video encoder as claimed in claim 1 further comprising a quantiser for quantising the relative frames prior to splitting and an inverse quantiser for performing an inverse quantisation on the first data subsets prior to generation of motion compensation parameters.

4. A video encoder as claimed in claim 1 wherein the transmitter is operable to transmit the motion compensation parameters and the first data subsets as a base layer, and the second data subsets as at least one enhancement layer.

5. A video encoder as claimed in claim 1 wherein the first data subset comprises data of relatively higher quality importance than data of the second data subsets.

6. A video encoder as claimed in claim 5 wherein the first data subsets comprises data corresponding to lower spatial frequencies than data of the second data subsets.

7. A video encoder as claimed in claim 6 wherein the splitter is operable to divide data of the relative frames having spatial frequencies below a threshold into the first data subsets and data of the relative frames having spatial frequencies not below the threshold into the second data subsets.

8. A video encoder as claimed in claim 1 wherein the transmitter is operable to generate and transmit progressively scalable data streams for at least one of the first and second data subsets.

9. A video encoder as claimed in claim 1 wherein the transmitter is operable to transmit the data of at least one of the first and second data subsets in order of decreasing video quality importance.

10. A video encoder as claimed in claim 9 wherein the transmitter is operable to transmit the data of the at least one of the first and second data subsets in order of increasing associated spatial frequency.

11. A video encoder as claimed in claim 10 wherein the transmitter is operable to arrange the data of the at least one of the first and second data subsets into subband groups comprising all data values of at least one of the relative frames having substantially identical associated spatial frequencies, and to sequentially transmit each subband group in order of increasing associated spatial frequency.

12. A video coder as claimed in claim 1 wherein the video encoder is a video transcoder, and the received video frames are compressed video frames.

13. A method of video encoding for video frames; the method comprising the steps of:
receiving the video frames;
deriving relative frames from the received video frames and predicted frames;
splitting the data of the relative frames into first data subsets and second data subsets;
generating motion compensation parameters in response to the received video frames and only the first data subsets of the first and second data subsets;
generating the predicted frames in response to the motion compensation parameters, the first data subsets and the received video frames; and
transmitting a video signal comprising the motion compensation parameters, the first data subsets and the second data subsets.

14. A computer program enabling the carrying out of a method according to claim 13.
